(19) United States
(12) Patent Application Publication
(10) Pub. No.: US 2011/0168852 A1
(43) Pub. Date: Jul. 14, 2011

(54) METHOD OF DEPOSITING A COATING FOR IMPROVING LAMINAR FLOW

(75) Inventors: Alain Porte, Colomiers (FR); Philippe Descamps, Reze (FR)

(73) Assignee: AIRBUS OPERATIONAS SAS, Toulouse (FR)

(21) Appl. No.: 12/996,446

(22) PCT Filed: Jun. 3, 2009
(86) PCT No.: PCT/FR2009/051048

§ 371 Date: Mar. 4, 2011

(30) Foreign Application Priority Data
Jun. 6, 2008 (FR) 0853758

(51) Int. Cl. B64D 33/02; B05D 3/00; B05D 5/00; B64D 29/00; B23P 11/02

(52) U.S. Cl. 244/53 B; 427/299; 29/449

(57) ABSTRACT

A process for deposition of a coating whose purpose is to improve the laminar flows at a junction between a first panel (36) of a leading edge and a second panel (34) of an adjacent surface according to the direction of the flows, characterized in that it includes the following stages:
determining the theoretical continuous surface (46) at the junction,
producing a shallow groove (48) relative to the theoretical continuous surface (46), which extends over a width such that the outside surfaces of the panels (34, 36) do not project further relative to the theoretical surface (46), and
depositing a coating (50) in the groove (48) in such a way as to fill it in.

This invention relates to a process for deposition of a coating whose purpose is to improve the laminar flow at the junction of a leading edge and an adjacent surface, more particularly suitable for improving the laminar flow at the junction of a lip and an outside surface of a nacelle.

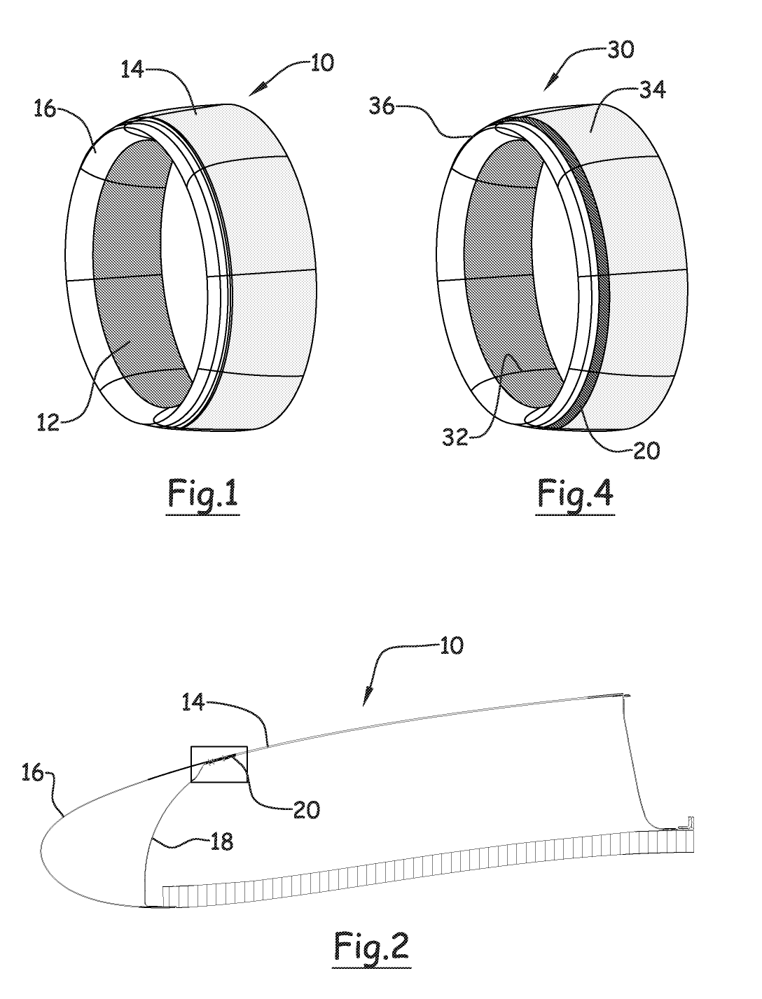

FIGS. 1, 2 and 3 show a nacelle 10 that comprises at least one inside pipe 12, an outside surface 14, and, at the front, an air intake that is delimited by a lip 16 that connects the inside pipe 12 and the outside surface 14.

The walls of the inside pipe, the lip, or the outside surface are obtained by the assembly of several panels, several plates, several skins, or the like. Hereinafter, all of these wall forms will be referred to by the term panel.

The structure of the nacelle comprises a front frame 18 that connects the outside surface 14 and the inside pipe 12, and that supports the lip 16. The front frame 18 comprises a first edge that is arranged at the junction of the outside surface 14 and the lip 16 and a second edge that is arranged at the junction of the inside pipe 12 and the lip 16.

At the first edge, the front frame 18 comprises a support surface 20 at the level of which the outside surface 14 and the lip 16 are made integral using attachment means 22. To reduce the influence on the drag, the panels of the outside surface 14 and the lip 16 are placed end to end and do not overlap.

This type of arrangement is not completely satisfactory for the following reasons:

The attachment means 22, generally rivets that are flush with the aerodynamic surfaces, generate disturbances that tend to increase the drag and consequently the energy consumption of the aircraft.

Even if it is possible to correct the variations between the thicknesses of the panels that are placed end to end using peel-off or machinable wedges 24, the lack of surface continuity between the outside surfaces of the panels that are placed end to end cannot be corrected. This lack at the junction of the panels of the outside surface 14 and the lip 16 generates disturbances that tend to increase the drag and consequently the energy consumption of the aircraft.

By way of example, the patent FR-2,787,509 describes rivets that are flush for connecting an acoustic panel to an air intake.

Also, the purpose of this invention is to eliminate the drawbacks of the prior art by proposing a process for deposition of a coating for improving the laminar flows at the junction zone between a leading edge and another adjacent surface.

For this purpose, the invention has as its object a process for deposition of a coating whose purpose is to improve the laminar flows at a junction between a first panel of a leading edge and a second panel of an adjacent surface according to the direction of said flows, characterized in that it comprises the following stages that consist in:
Determining the theoretical continuous surface at said junction,
Producing a groove of shallow depth d relative to the theoretical continuous surface, which extends over a width 1 such that the outside surfaces of said panels do not project further relative to the theoretical surface,
Depositing a coating in the groove in such a way as to fill it in.

According to one application, the invention has as its object an aircraft nacelle that comprises an inside pipe, an outside surface, and, at the front, an air intake that is delimited by a lip that connects the inside pipe and the outside surface, characterized in that it comprises, at the junction between said lip and the outside surface, a shallow groove relative to the theoretical continuous surface of said junction, which extends over a width such that the outside surfaces of the panels of said lip and the outside surface do not project further relative to the theoretical surface, and a coating that is arranged in the groove in such a way as to fill it in.

Other characteristics and advantages will emerge from the following description of the invention, a description that is provided only by way of example, relative to the accompanying drawings in which:

FIG. 1 is a perspective view of the front of a nacelle of an aircraft according to the prior art,

FIG. 2 is a cutaway along a longitudinal plane of a portion of the front of an aircraft nacelle,

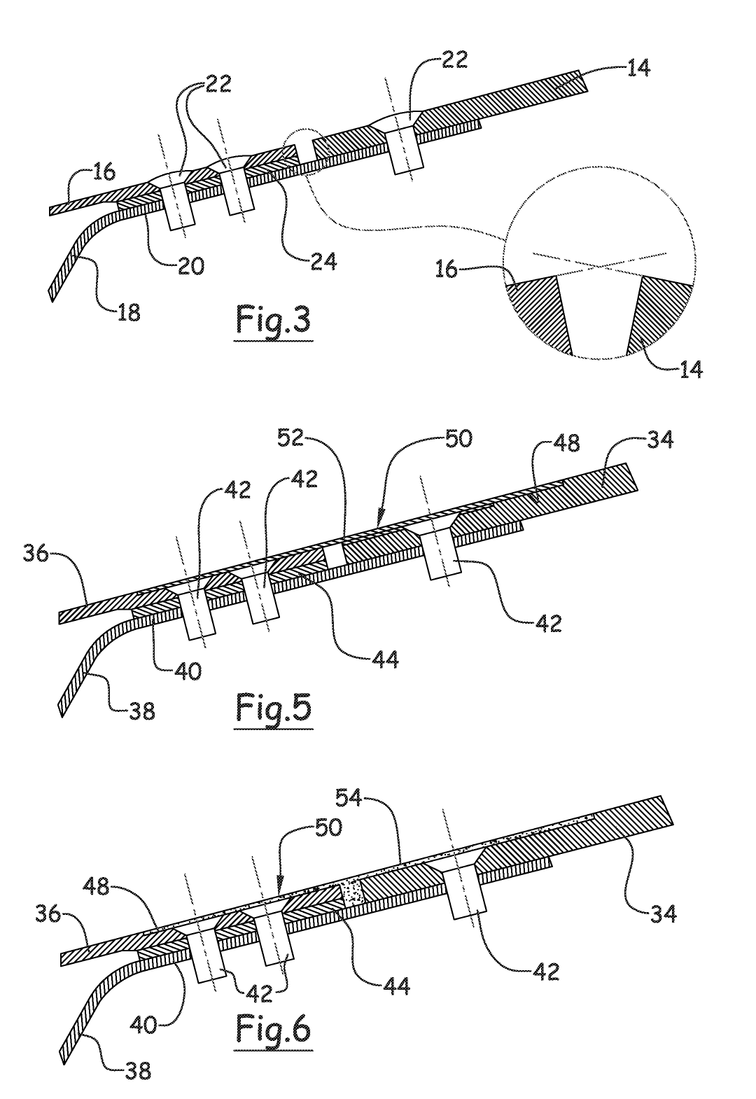

FIG. 3 is a cutaway that illustrates the junction zone of the lip and the outside surface of a nacelle according to the prior art,

FIG. 4 is a perspective view of the front of a nacelle according to the invention,

FIG. 5 is a cutaway that illustrates the junction zone of the lip and the outside surface of a nacelle according to a first variant of the invention,

FIG. 6 is a cutaway that illustrates the junction zone of the lip and the outside surface of a nacelle according to another variant of the invention,

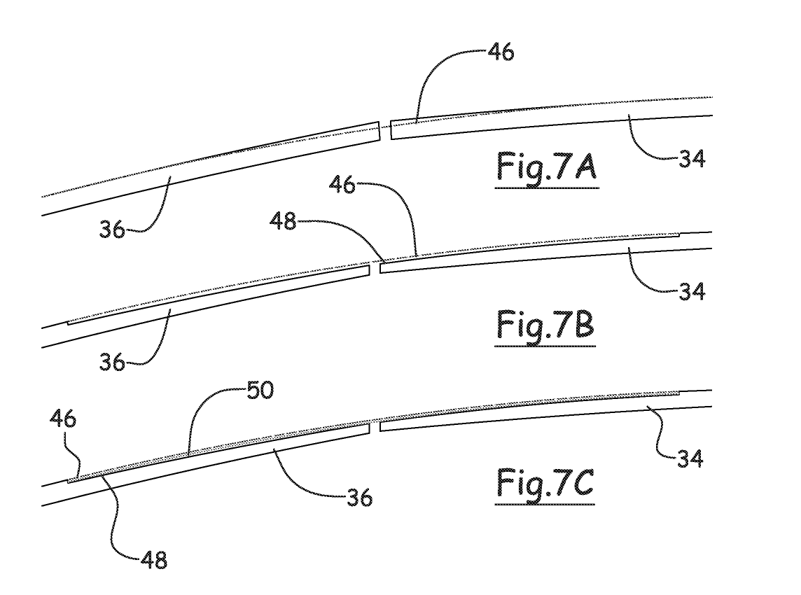

FIGS. 7A and 7C are cutaways that illustrate the different stages of the installation of the coating according to the invention, and

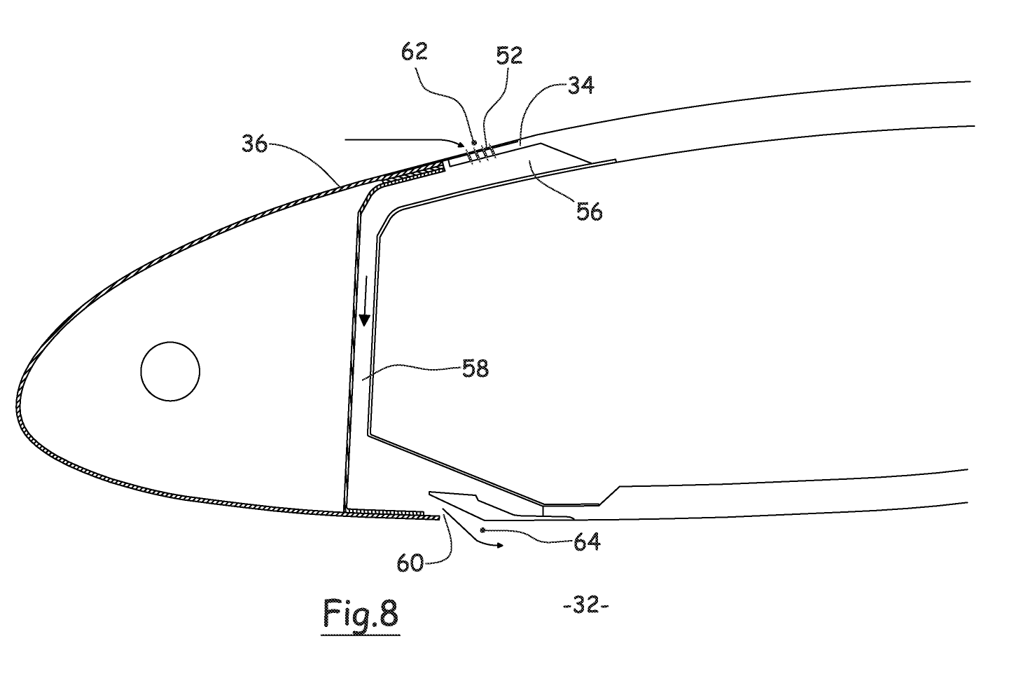

FIG. 8 is a cutaway along a longitudinal plane of a portion of the front of an aircraft nacelle that illustrates the formation of a stream of air between the outside and the inside of the nacelle.

At 30, FIGS. 4, 5 and 6 show a nacelle that comprises an inside pipe 32, an outside surface 34, and, at the front, an air intake that is delimited by a lip 36 that connects the inside pipe 32 and the outside surface 34. The other elements are not shown and described because they are known to one skilled in the art.

The inside pipe and the outside surface are obtained by the assembly of several panels, several plates, several skins or the like. Hereinafter, all of these wall forms will be referred to by the term panel.

The inside pipe, the outside surface, and the lip can be metallic and/or made of a composite material.

As for the inside pipe, the wall of the lip is formed by a panel or a panel assembly.

The structure of the nacelle comprises a front frame 38 that connects the outside surface 34 and the inside pipe 32 and that supports the lip 36. The front frame 38 comprises a first edge that is arranged at the junction of the outside surface 34 and the lip 36 and a second edge that is arranged at the junction of the inside pipe 32 and the lip 36.

At the first edge, the front frame 38 comprises a support surface 40 at the level of which the outside surface 34 and the lip 36 are made integral using attachment means 42, for example one or several series of rivets. To reduce the influence on the drag, the panels of the outside surface 34 and the lip 36 are placed end to end and do not overlap.

As appropriate, at least one wedge 44 can be interposed between the support surface 40 of the front frame and the panel of the outside surface 34 and/or the lip 36 so as to compensate for the possible difference in thickness between the two panels that are placed end to end at the junction zone.

The outside surfaces of the panels are not continuous at the junction, in particular because of differences in the curvature radii of the panels that are placed end to end. Thus, there is a difference between the theoretical continuous surface 46 of the junction, shown in dotted lines on the surface 7A, and the outside surfaces of the panels that are placed end to end that comprise a projecting portion relative to said theoretical continuous surface at the junction.

According to the invention, once the panels are assembled, as illustrated in FIG. 7A, the theoretical continuous surface 46 is determined by taking measurements, for example, on either side of the junction on the periphery of the nacelle.

Next, a removal of material is done, for example, by machining, so that the outside surfaces of the panels of the outside surface 34 and the lip 36 do not project further relative to the theoretical surface. A shallow groove 48 is made relative to the theoretical continuous surface 46, which extends, along a cutaway that is perpendicular to the junction, over a width on either side of said junction, approximately from the point of divergence between the outside surface of the panel of the lip 36 before machining and the theoretical continuous surface 46, up to the point of divergence between the outside surface of the panel of the outside surface 34 before machining and the theoretical continuous surface 46, as illustrated in FIG. 7B.

This groove 48 extends over the entire periphery of the nacelle, over 360°.

Advantageously, the width of the groove is such that the coating covers the attachment means.

After this removal of material, a coating 50 is arranged in the groove 48 in such a way as to fill it in. The thickness of the coating 50 is approximately equal to the depth d of the groove so that the outside surface of said coating assumes the shape of the theoretical continuous surface, as illustrated in FIG. 7C.

According to a first variant that is illustrated in FIG. 5, the coating 50 comprises a piece of sheet metal 52 that is also called a hoop, with a relatively small thickness, approximately equal to the depth of the groove 48, and with a width that is approximately equal to that of the groove 48 so as to assume perfectly the shape of said groove 48. Advantageously, the piece of sheet metal 52 is stretched during the deposition and held by tension once attached so that its outside surface is essentially merged with the theoretical continuous surface 46. Advantageously, the piece of sheet metal 52 is shaped in advance on a mold.

This piece of sheet metal 52 comprises an attachment zone for closing the hoop, representing a reduced zone that is likely to generate negligible turbulence relative to the gain in laminarity provided. This attachment zone can be replaced by a polished welding bead that considerably limits the generation of turbulence.

The piece of sheet metal 52 can be metallic. Its material is selected so that its expansion coefficient is adapted to those of the other adjacent elements of the nacelle.

According to another variant that is illustrated in FIG. 6, the coating 50 is obtained by the application of a film or a paint 54 whose purpose is to fill in the groove 48 in such a way that the outside surface of the coating 50 is essentially merged with the theoretical continuous surface 46.

According to one embodiment, the coating 50 is a silicone-based anti-corrosion paint, whereby said paint is applied by any suitable means in one or more layer(s) based on the thickness of the groove 48.

The material of the coating is selected in such a way as to have a certain elasticity so as to adapt to dimensional variations arising from the expansion phenomena.

The space between the panels can be filled in with the same material as the coating or with another material.

Unlike the variant of FIG. 5, the application of a film or a paint does not require an attachment as in the case of a hoop, which makes it possible to optimize the laminarity.

According to another characteristic of the invention, the coating 50, in particular the piece of sheet metal 52, is perforated and preferably microperforated for allowing a stream of air to run through said coating 50.

In this case, as illustrated in FIG. 8, a cavity 56 is provided under the coating 50 in such a way as to collect the air that runs through said coating, whereby this cavity extends over at least a portion of the periphery and preferably over the entire periphery. At least one pipe 58 connects this cavity to at least one opening 60 that empties into the inside pipe 32. Preferably, the openings 60 have shapes that are suitable for ejecting air into the inside pipe 32 in a tangential manner to the surface of said pipe in the direction of flow of the stream of air channeled through the air intake of the nacelle.

During flight, to the extent that there is a difference in pressure between a point 62 that is placed outside of the nacelle close to the coating 50 and a point 64 located in the inside pipe 32 close to an opening 60, an air stream is created in a natural manner between its two points 62 and 64 in the direction of the point 64 that is placed inside the inside pipe 32. This air stream that is generated in a natural manner and ejected via openings that empty into the inside pipe can make it possible to limit the risks of separation of the stream of air that flows into the inside pipe 32.

Of course, the invention is obviously not limited to the embodiment shown and described above, but in contrast covers all of the variants, in particular relative to the forms, the sizes and the material of the coating.

1. Process for deposition of a coating whose purpose is to improve the laminar flows at a junction between a first panel (36) of a leading edge and a second panel (34) of an adjacent surface according to the direction of said flows, characterized in that it comprises the following stages that consist in:
Determining the theoretical continuous surface (46) at said junction,
Producing a shallow groove (48) relative to the theoretical continuous surface (46), which extends over a width such that the outside surfaces of said panels (34, 36) do not project further relative to the theoretical surface (46), and
Depositing a coating (50) in the groove (48) in such a way as to fill it in.

2. Process for deposition of a coating whose purpose is to improve the laminar flows according to claim 1, wherein the thickness of the coating (50) is adjusted in such a way that the outside surface of said coating (50) is merged with the theoretical continuous surface (46).

3. Process for deposition of a coating whose purpose is to improve the laminar flows according to claim 1, wherein the coating (50) comprises a piece of sheet metal (52), with a relatively small thickness, approximately equal to the depth of the groove (48), and with a width that is approximately equal to that of the groove (48) so as to perfectly assume the shape of said groove (48).

4. Process for deposition of a coating whose purpose is to improve the laminar flows according to claim 3, wherein the piece of sheet metal (52) is stretched during the deposition and held by tension once attached.

5. Process for deposition of a coating whose purpose is to improve the laminar flows according to claim 1, wherein the coating (50) is obtained by the application of a film or a paint (54) whose purpose is to fill in the groove (48) in such a way that the outside surface of the coating (50) is essentially merged with the theoretical continuous surface (46).

6. Aircraft nacelle that comprises an inside pipe (32), an outside surface (34), and, at the front, an air intake that is delimited by a lip (36) that connects the inside pipe (32) and the outside surface (34), wherein it comprises, at the junction between said lip (36) and the outside surface (34), a shallow groove (48) relative to the theoretical continuous surface (46) of said junction, which extends over a width such that the outside surfaces of the panels of said lip (36) and the outside surface (34) do not project further relative to the theoretical surface (46), and a coating (50) that is arranged in the groove (48) in such a way as to fill it in.

7. Aircraft nacelle according to claim 6, wherein the coating (50) has a thickness such that the outside surface of said coating (50) is merged with the theoretical continuous surface (46).

8. Aircraft nacelle according to claim 6, wherein the coating (50) comprises a piece of sheet metal (52), with a relatively small thickness, approximately equal to the depth of the groove (48), and with a width that is approximately equal to that of the groove (48) so as to perfectly assume the shape of said groove (48).

9. Aircraft nacelle according to claim 6, wherein the coating (50) is a film or a paint (54) whose outside surface is essentially merged with the theoretical continuous surface (46).

10. Aircraft nacelle according to claim 9, wherein the coating (50) is a silicone-based anti-corrosion paint.

11. Process for deposition of a coating whose purpose is to improve the laminar flows according to claim 2, wherein the coating (50) comprises a piece of sheet metal (52), with a relatively small thickness, approximately equal to the depth of the groove (48), and with a width that is approximately equal to that of the groove (48) so as to perfectly assume the shape of said groove (48).

12. Process for deposition of a coating whose purpose is to improve the laminar flows according to claim 2, wherein the coating (50) is obtained by the application of a film or a paint (54) whose purpose is to fill in the groove (48) in such a way that the outside surface of the coating (50) is essentially merged with the theoretical continuous surface (46).

13. Aircraft nacelle according to claim 7, wherein the coating (50) comprises a piece of sheet metal (52), with a relatively small thickness, approximately equal to the depth of the groove (48), and with a width that is approximately equal to that of the groove (48) so as to perfectly assume the shape of said groove (48).

14. Aircraft nacelle according to claim 7 wherein the coating (50) is a film or a paint (54) whose outside surface is essentially merged with the theoretical continuous surface (46).
